(19) United States
(12) Patent Application Publication
(10) Pub. No.: US 2007/0021962 A1
(43) Pub. Date: Jan. 25, 2007

(54) Dialog control for dialog systems

(75) Inventor: Martin Oerder, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/571,643

(22) PCT Filed: Oct. 6, 2004
(86) PCT No.: PCT/IB04/51995

§ 371 Date: Apr. 5, 2006

(30) Foreign Application Priority Data
Oct. 10, 2003 (EP) 03103755.9

(51) Int. Cl. G10L 21/00

(52) U.S. Cl. 704/275

(57) ABSTRACT

A method and a system for developing a dialog control (DS) for a dialog system is described, which on the one hand has the task of controlling the dialog with the user and on the other hand monitors the speech user interface (SP) and the application (AP) of the dialog system. First of all a graphic dialog description (GB) is produced, which during the development process is displayed by a display device of the development system. Subsequently, the graphic dialog description (GB) is converted into a technical dialog description (TB) which comprises classes of an object-oriented translator language and translates these into a binary format, which ultimately represents the dialog control (DS) that can be executed by the dialog system.

The invention relates to a method and a system for producing a dialog control for a dialog system, as well as a dialog system with a dialog control of this type.

Dialog controls for speech-controlled user guidance of a dialog system have a broad commercial application field for speech portals of all kinds, e.g. in the case of speech-controlled information and service provision systems such as telephone banking and the home dialog systems. Speech-dialog systems of this type have a speech input interface, via which the speech utterances of a user are recorded and evaluated, and also as a rule a device for speech generation and speech output. As a central control component, the dialog systems have a dialog control. This dialog control implements all valid speech dialogs in the form of predetermined, mutually conditional, reciprocal sub-dialogs between the system and the user, as well as the system-side responses that can be derived from that. The network of valid dialogs and their conditional dependencies can become relatively extensive in the case of dialog systems with correspondingly complex specification.

In principle, such a dialog control can be realized in the form of hardware, for example as a ROM chip. Such hardware solutions are superior to a software solution in terms of execution speed, but offer no possibilities for adaptation to changed conditions. It is therefore sensible to realize the dialog control as software, and to make it available as such to the dialog system for execution.

In the development and production of speech-controlled dialog systems, the general problem arises that where the dialog system that is to be controlled is of corresponding complexity, on the one hand it is difficult for the dialog developer to gain an overview of the dialog control. On the other hand, with each alteration to the specification of the dialog system, the so-called dialog description, a corresponding adaptation of the dialog control or the dialog description must take place, the fast and accurate feasibility of which is in turn restricted by the complexity of the dialog description. Depending on the type or application of the dialog system, such alterations, e.g. as a result of changes in the ranges of goods and services on offer from an automatic sales system or their prices, may need to be carried out very frequently.

Typically, a dialog control with a specific development system is produced by a dialog developer and subsequently loaded into the dialog system, where it is executed by its run-time system. If an alteration to the dialog description is necessary, the dialog control must be read into the development system, updated accordingly there, and subsequently loaded into the run-time environment of the dialog system again. These days, mostly proprietary description and specification languages are used, these being mostly programming languages with a range of instructions specially tailored to the task. These languages have the disadvantage that the dialog developer has to learn them especially for the purpose of specifying the dialog control. Likewise, a client of the manufacturer of a dialog system or an external service provider can make an adaptation or change to the dialog description only after extensive training. That makes such systems extremely inflexible, and unusable for some application areas. Furthermore, the dialog descriptions that are to be produced or altered are often so complex that the development process or maintenance process can take up a considerable amount of time in the given framework of the proprietary language.

Such specification languages for dialog controls are mostly script languages which are executed on the dialog system by an interpreter. This has the principal disadvantage that due to the interpretation, the execution speed of such dialog controls in the run-time environment of the dialog system is limited. Likewise, the development times of script-language programs that reach a certain level of complexity are longer due to their being more difficult to structure. It may even be necessary, due to current technological developments, to expand the range of instructions or powerfulness of the specification language. This leads to the further disadvantage that both the interpreter of the development system and the interpreter of the dialog system must be adapted to the new range of instructions.

In principle it is also possible to realize the drafting of a dialog control with the means of graphic or visual programming. However, considerable difficulties can arise here in mastering the complexity of an extensive dialog description, since graphic tools as a rule provide only proprietary methods with a specially tailored and therefore restricted range of command structures and monitoring structures. The graphically developed dialogs developed in this way can then be made available to the dialog system in the form of a script-language program as dialog control. However, graphic development systems that can be realized in this way do not have the necessary power to develop dialogs of any desired complexity.

It is therefore an object of the present invention to enable simple, flexible, fast and economical new production and adaptation of a dialog control for a dialog system.

This object is achieved for one thing by a method for producing a dialog control for a dialog system, in which an application developer first of all produces a graphic dialog description by selecting and combining suitable graphically-represented dialog components. Here, the graphic dialog description is visualized by a display device. The dialog components can for example typically represent frequently-occurring and re-usable standard sub-dialogs, such as greeting and closing dialogs, identification dialogs or information inquiries. Likewise, structural components of a dialog, such as for example the states that a dialog control can assume, or state transitions, can be represented graphically. The dialog developer can take these from an archive (e.g. from a dialog database or dialog library), and on the basis of the visualization of the graphic dialog description, via well-defined interfaces, can link them appropriately to the components that have already been selected. According to the invention, this graphic dialog description is subsequently automatically converted into a technical dialog description, which represents the created dialog in the form of program codes of an object-oriented translator language. Since such universal programming languages (e.g. Java, C++ or C#) are generally more powerful in terms of calculation than graphic description languages, the functionality of the graphic dialog description can be mapped in every case, through the conversion, onto an equivalent technical dialog description. After the developer has produced the dialog on the technical levels completely to his wishes, the technical dialog description is then translated into machine code using a suitable compiler, forming the dialog control, and can be installed on the dialog system for its immediate use. Compared with the usual use of a dialog control that has been produced in an interpreter language or script language, this has the advantage that the dialog control is available in machine code, and in this respect works fast and reliably on the dialog system, whereas script programs must be interpreted through slower interpreters.

A significant advantage to using a universal rather than a proprietary programming language lies in the possibility of being able to realize any conceivable dialog. This yields the further advantage that such dialog controls can be expanded at any time without expenditure, and can be adapted to any technical or market-economy development.

The technical dialog description comprises classes of the object-oriented programming language that has been used, which on the one hand can be derivations from basic classes and thus inherit certain characteristics of these basic classes, and on the other hand can include sub-classes for sub-dialogs, dialog states or dialog transitions. In this way, class hierarchies can arise which as a whole represent the technical dialog description and ultimately specify the dialog control completely.

Dialog components or dialog modules that are written in any desired object-oriented programming language have the advantage that due to the data encapsulation caused by the structure of the language, and the precise definition of interfaces, they are in principle re-usable, and can therefore be used again efficiently for subsequent new developments of dialog controls.

The dialog developer who has developed a dialog on the graphic level, through graphic selection and combination, can preferably execute and refine the dialog more precisely on the technical level through programming. Thus for example standard utterances of the dialog system on the technical description levels can be adapted to a concrete dialog situation, or the inquiry options open to a user that are specified in a (graphic) sub-dialog can be expanded by the addition of others.

The new writing of dialog classes on the technical description level can be favorable for especially experienced dialog developers if they can program the dialog faster than they can develop it graphically. Likewise, the technical programming approach to development is preferable if for example a dialog class of a particular level of abstraction is required, which inherits characteristics and methods from one or more classes, and a similar class is not available in a database for dialog classes. It can also be the case that certain dialog situations cannot be realized, or can be realized only with difficulty, by a graphic description language that does not have full calculation capability. In such cases, the dialog developer has the option of further developing the technical dialog description with a programming language that does have full calculation capability, and writing new object-oriented classes that realize the concrete sub-dialog, in order to incorporate these into the technical dialog description.

In any case, it is a particular advantage of the invention that the development of a dialog control can proceed in a particularly flexible and problem-oriented manner, both on a graphic and on an equivalent programming-language level.

A further advantage of this distributed dialog development lies in the fact that the dialogs of speech-controlled dialog systems—these dialogs being present only in acoustic form in later operation, and these dialog systems these days being capable of reaching a considerable degree of complexity—are visualized on a graphic description level. The dialog developer can thus obtain a better overview of them, and design them better. The intermediate step of conversion into a technical dialog description enables the dialog developer to adapt the graphic design of the dialog control precisely to the requirements set by the dialog system, or to the wishes of a client.

Here, the use of a conventional programming language such as Java or an object-oriented C-derivative instead of a proprietary dialog description language is particularly advantageous, since thus not only the producer of the dialog system but also for example the client's maintenance personnel or specialized service providers can develop the dialog control, and adapt it if necessary. All that is required here is instruction in the programming interface (API) of the system. In principle, any object-oriented programming language can be chosen here.

In order to ensure consistency between the graphic and the technical dialog description, in one embodiment of the invention it is possible to integrate a textual alteration of the technical dialog description into the graphic dialog description again. The possible difference in powerfulness of the graphic and technical description languages poses no problem in the updating of the graphic dialog description, since through the strict syntax of an object-oriented programming language and its hierarchical structure due to inheritance and abstraction mechanisms, each dialog class can be graphically symbolized with its dependencies and interfaces.

In a particularly advantageous embodiment of the invention, the conversion of the graphic dialog description into a technical one, as well as the updating of the graphic dialog description by the alterations of a technical dialog description, takes place in an automated manner, and in a manner that is transparent for the developer, in the background through the development environment. Through this, a quasi-parallel development by the dialog developer on both description levels simultaneously is even possible.

In the case of this embodiment, moreover, it is ensured that in the case of user-controlled conversion of a graphic dialog description into a technical dialog description, the consistency of the two descriptions is not endangered by simple overwriting of the possibly altered classes or components of the technical dialog description, but the surpluses of the technical dialog description compared with the graphic dialog description are preserved during conversion, and in turn are updated in the graphic dialog description.

The classes/components for producing technical dialog descriptions can be stored in full or in part, i.e. also individually, in a dialog database or library. In the case of one embodiment, such technical descriptions of dialogs or sub-dialogs that are stored in a dialog database can advantageously be read in from the dialog development environment and used as a starting point for the technical and—after updating—graphic new development of a dialog control. This enables the re-usability of program fragments, and thus a high speed and efficiency of development.

The technical dialog descriptions that are stored in full or in part in a database can comprise class hierarchies and class libraries that represent particular important characteristics of dialogs in several levels of abstraction. These class hierarchies too can, after being read into the development environment in the form of technical dialog descriptions, be represented as graphic dialog descriptions, in that the relations between the classes and the inherited methods and characteristics are visualized by suitable graphic symbols. From a class hierarchy that has been visualized in this way, a dialog developer can select the classes that are sufficiently specified for his requirements by selecting the corresponding symbol, and combine them appropriately with other dialog components. The precise specification of the individual sub-dialogs and of the interfaces between them can for example take place after a conversion of the selected and combined components into a technical dialog description by programming out the individual classes. In this way, an advantageous distributed dialog development is realized, in which the structure of a dialog control is realized on the clear graphic description levels, and the detailed work takes place on the technical description level through programming.

In the case of an advantageous embodiment of the method according to the invention, all technical components/classes of a technical dialog description are represented by symbols or as block lines or circle lines in the graphic dialog description. The graphic dialog description can then be represented as a complete state/transition diagram of the dialog that is to be realized through the dialog control. This has the advantage that the state/transition diagrams that are frequently used for drafting dialogs can be converted directly into a graphic and thus ultimately also a technical dialog description, if all classes or components already exist.

In the case of this embodiment of the invention, the characteristics and methods of a class can, advantageously, be made identifiable in the graphic dialog description as elements of the class through symbols. Each symbol can bear a label which bears additional information, such as e.g. input and output parameters or interfaces, or which possibly even states the complete program code of the method or of the class. Likewise the transitions between the individual dialog states are represented graphically, wherein each transition can be assigned a label with the corresponding statements and dialog steps of the system or of the user, which lead to the corresponding transition or which results in it. With a graphic dialog description that is represented in this way, the dialog developer can develop the linguistic, i.e. essentially acoustic, dialog graphically and specify it more precisely, through simple mouse operations such as e.g. dragging, moving, copying, inserting or cutting. In a particularly advantageous embodiment, by double-clicking on a symbol the dialog developer can open a text window in which he can make textual alterations to the corresponding components, or can program these. Through this kind of integration of graphic and textual development, convenient dialog development is made possible.

For such development of a dialog control for a dialog system, a development system according to the invention is required, which comprises at least a graphic dialog editor with which the graphic dialog description can be visualized and edited. This development environment for dialog systems also contains a converter which converts the graphic dialog description into a technical dialog description which consists of classes of an object-oriented programming language. This source code is then translated, by means of a translator (compiler) of the development system according to the invention, into binary description format, which ultimately represents the dialog control that can be executed on a dialog system.

For the reverse conversion of a technical description into an equivalent graphic dialog description, the development system preferably comprises an updater.

For adapting the technical dialog description which represents the source code of a dialog control, the development system preferably comprises a text editor for textual editing of the source code.

In a particularly advantageous embodiment of the invention, besides a text editor there is also a complete programming environment with integrated debugger, compiler and class browser for selecting object-oriented dialog classes.

An advantage of this development environment lies in the fact that complex and multi-layered acoustic dialogs can be drafted by a dialog developer on the graphic level by means of adequate tools for editing and visualization through visual programming, whilst he can realize the details in the technical dialog description through object-oriented programming by means of a complete programming environment.

As an advantageous embodiment of the invention, the development system that has been described is integrated into the run-time environment of the dialog system, so that the dialog description can advantageously be produced on that hardware platform on which it is taken into operation as the dialog control.

In the case of a dialog system that is controlled by a dialog control that has been developed with the development system described here, it is particularly advantageous that a translated dialog control can be integrated into the system during operation. Through this, the dialog control can be updated without the need for the system to be taken out of operation in order to install the updated dialog control. This is an advantage particularly for systems which, due to constant special offers, for example, need to be updated particularly frequently.

The invention will be elucidated with reference to the enclosed drawings and to example embodiments described hereinafter. In the drawings:

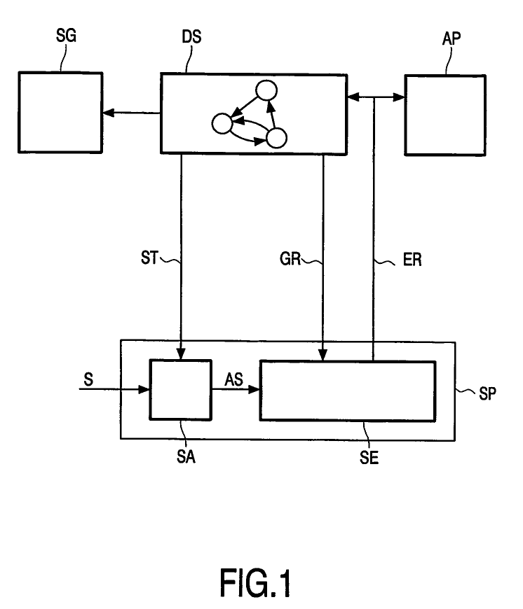

FIG. 1 shows a schematic representation of a dialog system,

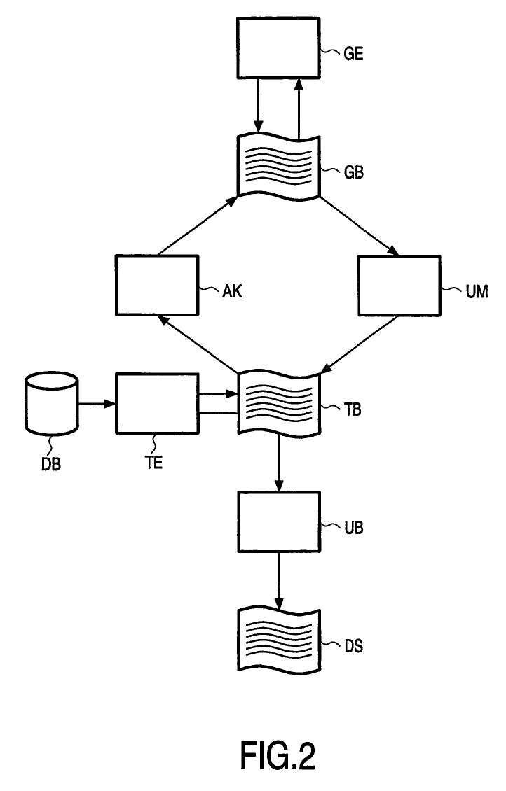

FIG. 2 shows a flow chart of development, according to the invention, of a dialog control,

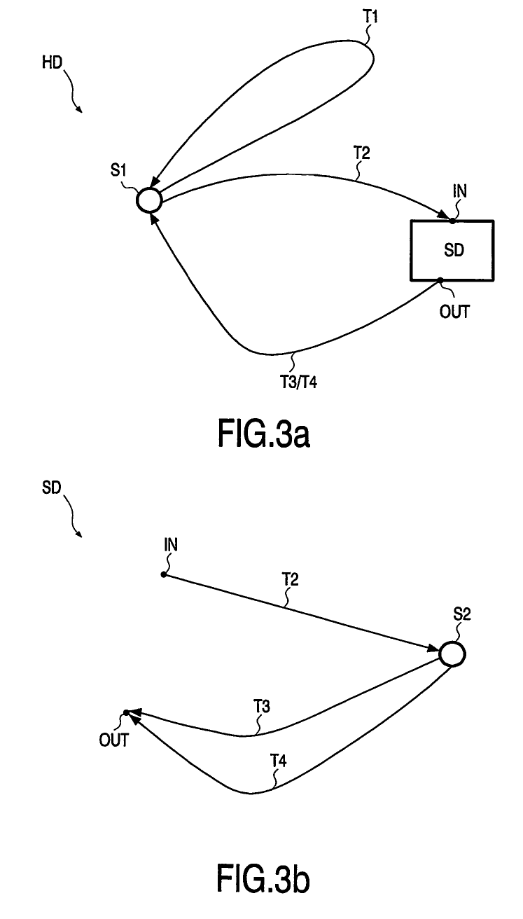

FIG. 3a shows a graphic representation of a dialog of a dialog system,

FIG. 3b shows a graphic representation of a sub-dialog of a dialog system,

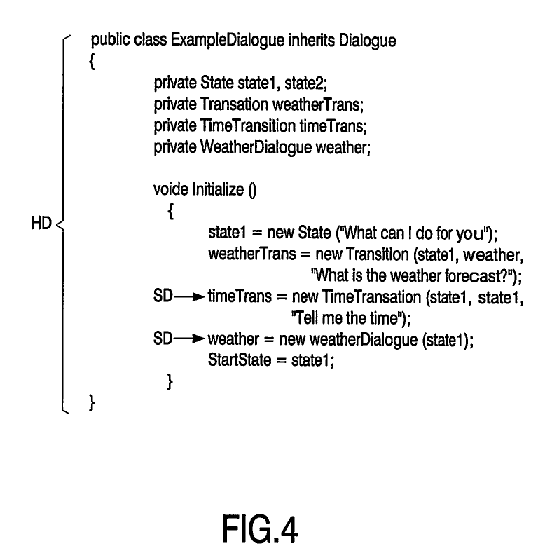

FIG. 4 shows an example of a technical dialog control,

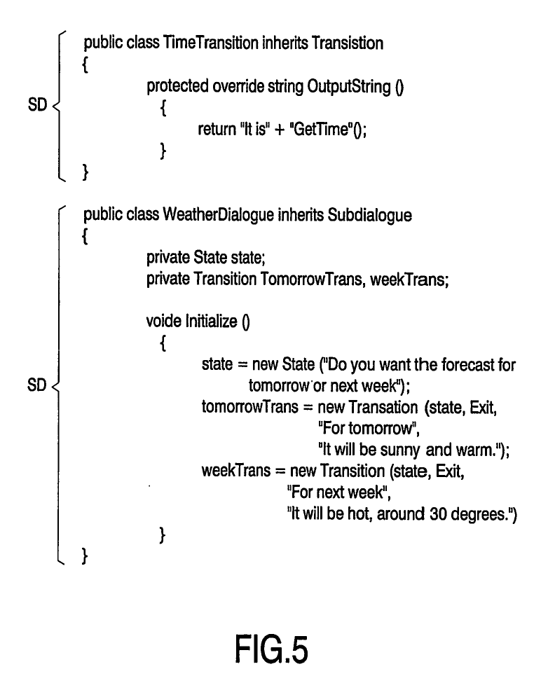

FIG. 5 shows two sub-dialogs of the technical dialog control shown in FIG. 4.

A design example of a dialog system with a dialog control DS according to the invention, which works together with an application AP, a speech generation unit SG and a speech input interface SP, is shown in FIG. 1. The dialog control DS controls the dialog system in accordance with the states, transitions and dialogs implemented by it.

An incoming speech utterance S is first of all converted into a digital audio speech signal AS by a signal recording unit SA of the speech input interface SP, and passed on to a speech recognition unit SE. The process of speech comprehension, i.e. the identification of an utterance known to the speech recognition unit SE, is initiated by the dialog control DS through a start signal ST.

As a rule, the speech recognition unit SE integrated into the speech input interface SP comprises a syntax analysis unit and a semantic synthesis unit (neither shown here), which check the validity of the digitized speech utterance AS according to a user grammar GR that is stipulated by the dialog control, and convert it into a recognition result ER which, as a response to the utterance of the user, comprises programming language or machine code instructions. The recognition result ER is on the one hand sent to the dialog control DS, in order to allow this to regain control of the dialog procedure, and on the other hand it is sent to the application AP, in order to be executed directly by it. Alternatively, the recognition result ER can be sent by the speech recognition unit SE only to the dialog control DS, in order to be passed on by this to the application AP.

The dialog control DS is thus the central switching point of the dialog system, since it specifies the dialogs that are to be accepted as valid by the speech recognition unit SE, and thereby indirectly controls the application AP. Furthermore, the dialog control DS also controls the speech generation unit SG, which in accordance with the dialog implemented in the dialog control DS, initiates generation of speech utterances by the system to the user.

As a rule, both the speech recognition unit SE of the speech input interface SP, the application AP and the dialog control DS are written in the same object-oriented translator language, or at least in a language that can be executed on the same platform.

FIG. 2 shows the schematic sequence of the development of a dialog control. It also shows all the important components of a dialog development environment according to the invention. This includes a graphic dialog editor GE which represents a display and editing device, with which a dialog developer can visualize and draft a dialog. For this, various basic components are available to him, such as e.g. dialogs, states and transition, which are realized technically as basic classes of a class hierarchy, and which he can select as graphic symbols in the graphic dialog editor GE and can combine appropriately with other components via well-defined interfaces.

The result of this first development cycle is a graphic dialog description GB, which initially exists only virtually, in the form of an internal representation of the editor. The graphic dialog description GB is converted into a technical dialog description TB by means of a converter UM, in that the individual (graphic) components of the graphic dialog description GB are converted into class instances of an object-oriented programming language. These class instances represent the graphic components in programming language form (cf. FIGS. 4 and 5), for example as instances of basic classes for dialogs, states and transitions, or in other words derived classes with inherited characteristics for particular sub-dialogs.

The technical dialog description TB created by the converter UM can be edited by the dialog developer by means of a text editor TE, which can be a portion of a perfected programming environment for the programming language created by the converter UM. Through the possibility of editing the technical dialog description TB, the dialog developer can program out the dialog control DS that is to be developed, i.e. supplement it by details which he either was not able to realize when drafting the graphic dialog description GB or which are easier for him to realize on the technical programming level.

Alterations which the dialog developer makes to the technical dialog description TB by means of the technical dialog editor TE can be re-integrated by an updater AK into the graphic dialog description, so that the two levels of abstraction of a dialog development remain consistent with one another. In the course of this, newly programmed classes/components or methods of the technical dialog description TB are visualized in the graphic dialog description GB by means of corresponding symbols, and these are linked according to the relations of the newly programmed component with other symbols of the graphic dialog description GB.

In a particularly advantageous embodiment of the invention, the updating AK is carried out such that through a renewed conversion UM of the updated graphic dialog description GB, a technical dialog description TB is created which (after translation by a suitable compiler) shows identical run-time behavior to that of the original technical dialog description TB that was altered by the dialog developer.

In a dialog database DB, sub-dialogs and standardized dialog elements are stored in the form of program codes, which can be read into the textual dialog editor TE as a technical dialog description TB, and altered by the dialog developer, as the basis for a dialog that is to be newly developed, or as an expansion/alteration of an existing dialog. Likewise, existing dialogs and dialog components can be stored in the database DB for later use. Since an object-oriented programming language is used for the technical dialog description TB, the dialog database DB can contain class hierarchies from which the dialog developer can select a class of the abstraction level that is appropriate for his purposes, for programming out. Starting from these class hierarchies and libraries, the development of a new dialog can take place on both the technical and the graphic description levels TB, GB, through derivation or inheritance and abstraction.

A finished technical dialog description TB is translated by a compiler UB into the machine code dialog control DS, which is finally integrated into the dialog system shown in FIG. 1.

The (deterministic) behavior of the dialog control DS can be formally described by means of a state/transition diagram that fully describes all the states of the system and the events that lead to a change of state (the transitions). FIG. 3 shows, by way of an example, the state/transition diagram of a simple dialog HD which is realized by the dialog control DS. The dialog HD can assume a state S1, has a sub-dialog SD that is not specified in any further detail, in which in turn at least one further state is specified, and also has four transitions T1, T2, and T3/T4, which are respectively initiated by a dialog step. The transition T1 maps the state S1 on itself, whilst the other transitions T2 and T3/T4 describe a change of state between the state S1 and one of the states specified in the sub-dialog SD.

The state S1 is the initial state or starting state of the dialog system, which it assumes again at the end of each dialog with the user. In this state, the system generates a start phrase which prompts the user to make an utterance: “What can I do for you?”. The two speech utterances “What time is it?” for initiating the transition T1 and “What is the weather forecast?” for initiating the transition T2 are now open to the user. In the first case, the system responds with the correct time and then completes the corresponding transition T1, in that it returns to the starting state S1, in order to give the starting utterance again. In the latter case, the system changes via the transition T2 and the input interface IN into the sub-dialog SD. From the sub-dialog SD, a transition T3/T4 leads via the output interface OUT back into the starting state S1, wherein the question posed in transition T2 is answered.

FIG. 3b shows the corresponding state/transition diagram of the sub-dialog SD. It shows a state S2 which is linked via an input interface IN and an output interface OUT with the higher-order main dialog HD shown in FIG. 3a. The sub-dialog SD has a state S2 which is reached via the transitions T2 from a state of the main dialog HD, and two transitions T3 and T4 which both undertake a change of state to a state specified in the main dialog HD.

After the dialog step “What is the weather forecast?” of the transition T2, for more precise specification of the user request, the sub-dialog SD responds with the counter-question “For tomorrow or for next week?” and changes into the new state S2. In state S2, the user can only answer the counter-question of the dialog control DS with the dialog steps “For tomorrow” or “For next week”. In state S2, he no longer has the option of asking the time; to do this, one would first have to leave the sub-dialog SD and the state S1 would have to be resumed. On clarification from the user, the dialog control DS answers differentially with the weather forecast “for tomorrow” or “for next week”, and by means of the corresponding transition T3 or T4 it branches via the output interface OUT back into the main dialog HD, and then back into the starting state S1.

The diagrams in FIGS. 3a and 3b represent an example of a graphic dialog description GB. The dialog developer design dialogs HD graphically through specification of the states S1, S2, transitions T1, T2, T3, T4 and sub-dialogs SD. Here, the dialog steps can be associated with the corresponding transitions T1, T2, T3, T4 through double-clicking and inputting of the text. In the conversion UM of the graphic dialog description GB into a technical dialog description, the components of the dialog HD (states, transitions and sub-dialogs) are converted into a programming language version in the form of classes of an object-oriented programming language. Such a conversion UM of the graphic dialog description from the FIGS. 3a and 3b is shown in FIGS. 4 and 5.

For elucidation, the following example technical dialog description TB is written in the object-oriented programming language C#. Fundamentally however any other object-oriented programming language is suitable for the definition of a technical dialog description TB. FIG. 4 shows the main dialog HD as a class “ExampleDialogue” which is derived from the basic dialog class “Dialogue” that is stipulated by the system and which inherits the characteristics of the class “Dialogue”. “ExampleDialogue” defines two states “state1” and “state2”, two transitions “WeatherTrans” and “timeTrans” and a sub-dialog “Weather”. Whereas the states “state1” and “state2” and the transition “WeatherTrans” are instances of the basic classes “State” and “Transition” for states and transitions, “timeTrans” and “Weather” form instances of two classes likewise implemented by the dialog developer, which in turn are derived from other basic classes and are specified in FIG. 5.

When instantiated by the calling up of four constructors, the InitializeO method of the class “ExampleDialogue” produces the objects “state1”, “WeatherTrans”, “timeTrans” and “Weather”. The object “state1” represents that starting state S1 which is associated with the dialog step which the dialog system initially communicates to the user. The object “WeatherTrans” represents a transition T2 which changes from the state “state1” S1 into a state of the sub-dialog SD “Weather”, and in so doing outputs the given phrase. The object “timeTrans” maps the state “state1” S1 onto itself, and the object “Weather” represents a sub-dialog SD, into which it is possible to branch from the state “state 1” S1.

For complete specification of the dialog HD, what is now missing is a specification of the classes “TimeTransition” and “WeatherDialogue” which are not yet known on this level, whose instances represent the objects “timeTrans” and “Weather”. These are shown in FIG. 5.

The class “TimeTransition” is derived from the class “Transition”, of which the object “WeatherTrans” of the main dialog HD already represents an instance. The class realizes only the answer to the question, which was already given as a parameter to the object “timeTrans” on its instantiation in the class “ExampleDialogue” of the main dialog HD.

The class “WeatherDialogue” is derived from the class “sub-dialogue”, which in turn contains a state “state” S2 and two transitions “TomorrowTrans” T3 and “WeekTrans” T4. This class represents the technical program conversion UM of the sub-dialog SD shown in FIG. 3b. It responds to the question about the weather forecast (cf. parameters of its instantiation in “ExampleDialogue”) in accordance with the state/transition diagram in the state “state” S2 with a counter-question, and then responds in a differentiated manner with the transition “tomorrowTrans” T3 or “WeekTrans”. By ending the sub-dialog with “Exit”, it then passes control back to the higher-order object of the class “ExampleDialogue”, which has instantiated the object “Weather” of the class “WeatherDialogue”.

The technical dialog description TB—comprising the three classes, described above, for realizing the main and sub-dialogs HD, SD—is finally translated into machine code by the compiler UB (cf. FIG. 2), and thereby forms the dialog control DS. For the run-time of the dialog control DS in a dialog system, a higher-order object of the class “ExampleDialogue” is instantiated by calling up the corresponding constructor, which through its instantiation in turn of further objects realizes the complete dialog.

To conclude, it is once again pointed out that the concrete dialog system represented by the Figures and the description, and the development system, are merely design examples, which the person skilled in the art can vary to a large extent without departing from the scope of the invention. In particular the program fragments, which in the design examples shown here are written in the object-oriented programming language C#, can be written in any other object-oriented programming language. It is furthermore clear that the dialog design examples shown here are very simple, short examples, which were selected in order to elucidate the invention as simply as possible. In reality the dialogs are naturally considerably more complex. For the sake of completeness, it is also pointed out that the use of the indefinite article “a” or “an” does not exclude the possibility that the features in question can also be present several times, and that the use of the term “comprise” does not exclude the existence of further elements or steps.

1. A method for producing a dialog control (DS) for a dialog system with a speech user interface (SP) and an application (AP), wherein die dialog control (DS) works together with the speech input interface (SP) and the application (AP), with the following steps:
production of a graphic dialog description (GB) comprising graphic dialog components, which during the production of the graphic dialog description (GB) are displayed by means of a display device,
conversion of the graphic dialog components of the graphic dialog description (GB) into technical dialog components of a technical dialog description (TB) in the form of classes of an object-oriented translator language and
translation of the technical dialog description (TB), whilst forming the dialog control (DS), into binary data that can be used directly by the dialog system.

2. A method as claimed in claim 1, characterized in that the technical dialog description (TB) can be textually altered, wherein if necessary the graphic dialog description (GB) is at least partially supplemented by the textual alterations of the technical dialog description (TB), and the supplemented graphic dialog description (GB) is displayed, and in the conversion of a graphic dialog description (GB) into a technical dialog description (TB) the textual alterations of the technical dialog description (TB) are taken into account.

3. A method as claimed in claim 1, characterized in that an existing technical dialog description (TB) is at least partly converted into a graphic dialog description (GB) as the basis for producing a new graphic dialog description (GB).

4. A method as claimed in claim 1, characterized in that given object-oriented classes of dialog description class hierarchies and/or dialog description class libraries are at least partially represented as graphic dialog components,
that the graphic dialog description (GB) is produced through graphic selection, combination and/or alteration of graphic dialog components,
and that the graphic dialog description (GB) is converted through derivation of the specified classes represented by the graphic dialog components into technical dialog components of a technical dialog description (TB) in the form of derived classes.

5. A method as claimed in claim 1, characterized in that specified sub-dialog descriptions are at least partially represented graphically as graphic dialog components, selected and integrated into a graphic dialog description (GB).

6. A method as claimed in claim 1, characterized in that in the case of the graphic dialog description (GB), all graphic dialog components are represented by symbols and the production of the graphic dialog description (GB) takes place through the selection, copying and linking of the symbols and alteration of the technical dialog components represented by the symbols.

7. A system for producing a dialog control (DS) for a dialog system with a speech input interface (SP) and an application (AP), wherein the dialog control (DS) works together with the speech input interface (SP) and the application (AP), comprising
a graphic dialog editor (GE) for visualizing and altering the graphic dialog components of a graphic dialog description (GB),
a converter (UM) for converting the graphic dialog components into technical dialog components of a technical dialog description (TB) in the form of classes of an object-oriented translator language,
and a translator (UB) for translating the technical dialog description, whilst forming the dialog control (DS), into binary data that can be used directly by the dialog system.

8. A system as claimed in claim 7, characterized by a textual dialog editor (TE) for altering the technical dialog description (TB) and an updater (AK) for at least partial supplementation of the graphic dialog description (GB) by the textual alterations of the technical dialog description (TB).

9. A system as claimed in claim 7, characterized in that it is operational in the same run-time environment as the dialog control (DS).

10. A dialog system with a dialog control (DS), a speech user interface (SP) and an application (AP), wherein the dialog control (DS) works together with the speech input interface (SP) and the application (AP), and the dialog control (DS) has been produced with a method as claimed in claim 1.

11. A dialog system as claimed in claim 10, characterized in that during operation, a new dialog control (DS) can be integrated and deployed.
